(19) United States
(12) Patent Application Publication
(10) Pub. No.: US 2026/0055569 A1
(43) Pub. Date: Feb. 26, 2026

(54) VIBRATION GENERATOR FOR A VIBRATING PILE DRIVER

(71) Applicant: ABI Anlagentechnik-Baumaschinen-Industriebedarf Maschinenfabrik und Vertriebsgesellschaft mbH, Niedernberg (DE)

(72) Inventors: Marvin KLEIN, Grossostheim (DE); Albrecht KLEIBL, Grosshennersdorf (DE); Manuel MEINEL, Leipzig (DE)

(73) Assignee: ABI Anlagentechnik-Baumaschinen-Industriebedarf Maschinenfabrik und Vertriebsgesellschaft mbH, Niedernberg (DE)

(21) Appl. No.: 19/252,224

(22) Filed: Jun. 27, 2025

(30) Foreign Application Priority Data
Jul. 3, 2024 (EP) 24186346.3

(51) Int. Cl. E02D 7/18; B06B 1/16

(52) U.S. Cl. CPC E02D 7/18; B06B 1/162

(57) ABSTRACT

A vibration generator for a vibrating pile driver includes a generator housing, in which a generator gear mechanism is arranged, which includes at least two parallel shafts rotatably mounted in bearings held by the generator housing, and connected to at least one drive to put them into rotation, and to at least two imbalance masses attached to one or more of the shafts. The at least one drive is formed by a drive unit, in each instance, which includes an electric motor and a drive gear mechanism connected to the motor. The drive unit is positioned on the generator housing, on the outside, offset from the bearings held by the generator housing, in the direction of the axes of rotation of the shafts, and not axially between two bearings of a shaft. The drive gear mechanism is connected to at least one of the shafts.

### CROSS REFERENCE TO RELATED APPLICATIONS

Applicant claims priority under 35 U.S. C. § 119 of European Application No. 24186346.3 filed Jul. 3, 2024, the disclosure of which is incorporated by reference.

### BACKGROUND OF THE INVENTION

### 1. Field of the Invention

The invention relates to a vibration generator for a vibrating pile driver, comprising a generator housing in which a generator gear mechanism is arranged, which mechanism comprises at least two shafts that are mounted so as to rotate and are arranged parallel to one another, which shafts are connected to at least one drive by means of which they are put into rotation, as well as to at least two imbalance masses that are attached to one or more of the shafts.

### 2. Description of the Related Art

In construction, vibration generators such as vibrators, shakers or vibration hammers are used to drive profiles into the ground or to pull them out, or also to compact soil material. The ground is excited by means of vibration and thereby achieves a “pseudo-liquid” state. The pile element can then be pressed into the construction ground or pulled out of it. The vibration is characterized by a linear movement and is generated by means of two rotating imbalances that run in opposite directions, in pairs, within a vibrator gear mechanism. Vibration generators are characterized by the installed imbalance (referred to in technical circles as “static moment”), the vibrating mass, the permissible centrifugal force, and the maximum speed of rotation.

Vibrators are used in vibrating pile drivers that are regularly arranged, as a leader-guided working device, on a support frame of a special underground construction device. Vibrating pile drivers are furthermore also used as an excavator attachment or also as so-called free riders. The drive of the vibrating pile driver takes place by way of hydraulic motors, which are connected to the shafts of the vibrator gear mechanism within the vibrator housing. Special underground construction machines are mobile working machines, and diesel engines are regularly used to drive them. Hydraulic pumps are driven by way of the diesel engine of the support frame, and these pumps drive the hydraulic motors of the vibrating pile driver by way of a hydraulic circuit.

Hydraulic motors have established themselves as the drive for the vibrators; these motors have a very robust structure and have a high power density and torque density. This means that they can make great drive power and a high drive torque available at compact dimensions and low mass.

The use of hydraulic pumps has proven itself in the case of such special underground construction machines, since they have a great power density and torque density at a simultaneously low construction size. By means of the use of hydraulic motors having a variable displacement, as it is taught in EP2085149A1, operation in different speed of rotation ranges, without any decrease in power, is possible.

It is a disadvantage of the previously known vibration generators, however, that the hydraulic motors themselves have a low degree of energy effectiveness. The degree of effectiveness is furthermore impaired by the fact that the hydraulic oil for driving the hydraulic motors of the vibrator is transmitted over long distances, at a large volume stream and high pressure, through relatively thin hose lines or pipelines, and this entails great energy losses in the hydraulic circuit. The viscosity of the hydraulic oil is furthermore greatly dependent on the temperature, and this results in great energy losses in the hydraulic circuit, in particular at low temperatures. Furthermore, the hydraulic motors need a complicated hydraulic system for operation, to the hydraulic pumps of which system the hydraulic motors are connected by way of a system of hydraulic hoses and control blocks. Furthermore, the risk of exit of hydraulic oil into the environment exists as the result of leakages at the hydraulic hoses or also when connecting a vibrator to the hydraulic system of a support frame, for example. The hydraulic system, which is furthermore also vulnerable to contamination, furthermore proves to be maintenance-intensive.

In WO2022023254 A1, a vibrating pile-driving device having a vibration generator is described, on the housing of which generator a permanent-magnet synchronous motor (PMSM) is arranged on two opposite sides, in each instance, which motor is connected to a drive shaft, in each instance, which shaft is provided with a gear wheel in the interior of the housing, which gear wheel meshes with a gear wheel of an imbalance shaft of the generator gear mechanism and drives this shaft. Alternatively, it is proposed to connect the permanent-magnet synchronous motors to the imbalance shafts directly, and to also allow a phase adjustment of the imbalances relative to one another by way of these shafts. It is a disadvantage of the solution described that permanent-magnet synchronous motors have a significantly lower torque density (torque with reference to construction space or mass) as compared to hydraulic motors, and thereby the construction size of the vibration generator is significantly increased and its ability to be used is restricted. Pile-driving close to existing impediments, such as, for example, existing buildings or closely next to other pile elements that have already been installed, which can be present in a great number of different embodiments, such as, for example, pipes, boxes, U-profiles or Z-profiles, is thereby impaired. Furthermore, the permanent magnets found in the permanent-magnet synchronous motors require rare earth metals, and their use is ecologically and socially questionable.

### SUMMARY OF THE INVENTION

This is where the present invention takes its start. The invention is based on the task of making available a vibration generator (also called a vibrator) for a vibrating pile driver, in which the aforementioned disadvantages are avoided and which has a compact structure, at the same time. This task is accomplished by means of a vibration generator having the characteristics according to the invention.

With the invention, a vibration generator for a vibrating pile driver is made available, in which the aforementioned disadvantages are avoided and which, at the same time, has a compact construction. Because of the fact that the at least one drive is formed by means of a drive unit, in each instance, which unit comprises an electric motor and a drive gear mechanism connected to it, wherein the drive gear mechanism is connected to at least one of the shafts, a high degree of effectiveness is achieved, with a compact construction at the same time. By means of the connection of the electric motor to a drive gear mechanism within the drive unit, the required size of the electric motor is significantly reduced. By means of the high speed of rotation of the electric motors that is possible, the use of smaller and lighter electric motors is possible by way of the drive gear mechanism, at the same power. Because of the fact that the at least one drive unit is arranged on the outside of the generator housing, in such a manner that it is positioned offset from the bearings held by the generator housing, in the direction of the axes of rotation of the shafts, and not axially between two bearings of a shaft, a compact method of construction is supported. The drive units are positioned outside of the housing, and thereby the space that can be used within the housing is maximized. In this regard, the drive units are connected to at least one shaft with their drive gear mechanism, on the outside, outside of the bearing location, wherein the connection is preferably arranged at the smallest possible distance from the adjacent bearing location of the shaft.

In an embodiment of the invention, at least one drive unit formed by a drive gear mechanism and an electric motor is firmly connected to the generator housing. Preferably, all the drive units provided are firmly connected to the generator housing.

In a further embodiment of the invention, the drive gear mechanisms of all the drive units are structured as gear wheel mechanisms and directly connected, in each instance, to at least one shaft of the generator gear mechanism. In this regard, no traction drive such as a V-belt drive or timing belt drive is present. In this way, the reliability of the drive that is subject to the impact of vibrations is increased.

It is advantageous if each of the shafts is provided with at least one imbalance mass, wherein preferably an intermediate shaft is provided, which does not have an imbalance mass. A shaft provided with at least one imbalance mass is also referred to as an imbalance shaft in the present case.

In an embodiment of the invention, at least two shafts of the generator gear mechanism, preferably all the shafts, are connected to a drive unit in each instance. In this way, a further reduction of the required construction height of the electric motors is achieved.

In a further embodiment of the invention, the drive gear mechanism of at least one drive unit comprises at least two, preferably precisely two meshing gear wheels, wherein one of the gear wheels is driven by the electric motor, and the other gear wheel is connected to one of the shafts. In this way, a compact structure of the drive unit is achieved. Furthermore, when precisely two gear wheels are provided, no additional slide bearings or roller bearings are needed.

In a further development of the invention, the drive gear mechanism of at least one drive unit has an output axle offset radially from the drive axle. In this way, more degrees of freedom are achieved in the placement of the motors. For example, the drive of two adjacent shafts of the generator gear mechanism is made possible by means of an electric motor, in each instance, wherein the enveloping circle diameter of the electric motor is greater than the distance between the two adjacent shafts. This particularly has an impact in a configuration of the vibration generator as an upright vibrator, in which at least three imbalance shafts are arranged one on top of the other.

A further advantage consists in that the motor shaft of the electric motor and the imbalance shaft are coupled only in one degree of freedom (angle of rotation), so that no radial or axial forces are transferred from the imbalance shaft to the motor shaft. This makes it possible to use electric motors without any specially modified or reinforced mounting of the shaft, i.e., of the rotor in generator gear mechanisms, without having to fear a drastic reduction in shelf life.

In the case of vibration generators in special underground construction, a distinction is made between two designs: A vibration generator having a vertical structure is referred to as an upright vibrator, in which at least three imbalance shafts are present and more imbalance shafts are arranged one on top of the other than next to one another. This design is suitable for pile-driving work and pulling work on a vibrating pile-driving device having a leader. By means of being guided on the leader, precise alignment of the pile element(s) and application of vertical top loads or pulling forces is significantly facilitated. Since the vibrator is attached to the leader, it can only be pivoted about the vertical axis in a limited manner. For this reason, in the case of upright vibrators, an effort is made to structure the vibration generator in a compact manner in the width direction and depth direction, so as to avoid collisions with impediments such as building walls or pile elements that have already been installed. In the case of the vertical structure of the generator gear mechanism, the horizontal centrifugal force components of the imbalances compensate with an offset from one another. The moment resulting in an imbalance pair from this arrangement is balanced out by the placement of the imbalance pairs relative to one another. Such an upright vibrator or vibration generator having a vertical structure is described, for example, in EP 2 789 402 A1.

Vibration generators having a horizontal structure are preferably used in the case of vibrators that are operated freely suspended on a crane or an excavator (so-called free-riding vibrating pile drivers or also free riders). In this way, they can be rotated about their vertical axis and freely positioned. In the case of a horizontal structure of the generator gear mechanism, the horizontal centrifugal force components of the imbalance pairs compensate one another in a horizontally arranged plane. The moment equilibrium is thereby inherently achieved.

In an embodiment of the invention, the gear wheel of the drive gear mechanism of the at least one drive unit that is driven by the electric motor is structured as a spur gear with teeth on the outside, wherein the gear wheel on the output side, which is connected to one of the shafts, is structured as a hollow gear wheel, wherein the motor shaft of the electric motor of the drive unit is arranged at a radial offset from the shaft. In this way, a compact, flat method of construction of the drive unit, together with a great translation of the drive gear mechanism, is achieved. Furthermore, by means of the embodiment as a hollow gear wheel with inner teeth, the axial distance between motor and imbalance shaft can be smaller than in the case of outer teeth with the same translation. This combination—small axial distance at great translation—is ideal for a vibration generator for a vibrating pile driver.

In a further development of the invention, at least two shafts are connected to one another by way of gear wheels.

In an embodiment of the invention, at least one motor of a drive unit is a synchronous motor excited from the outside, a reluctance motor or an asynchronous motor. These motors are characterized in that they do not require any permanent magnets, and thereby the environmentally harmful use of rare earths is avoided. These motors generally have a lower torque density than permanent-magnet synchronous motors. In order to achieve a comparable power output at the same weight and dimensions, these motors must be operated at a higher speed of rotation. This can easily be implemented, in the present case, by means of providing a correspondingly required translation of the drive gear mechanism.

In a further embodiment of the invention, at least one electric motor is a disk motor. In this way, a reduced construction height is achieved. The disk motor (also called an axial flux motor) is characterized by a low construction height with a large outside diameter, as well as a high torque density. By means of a drive gear mechanism having a radial axial offset between the drive axle and the output axle, multiple electric motors having an outside diameter that is greater than the axial distance between the imbalance shafts can be mounted on the housing of the generator gear mechanism, without the outside dimensions of the vibrator having to be increased. Furthermore, the principle of the disk motor offers structural advantages: The air gap between the rotor and the housing is oriented at a right angle to the axis of rotation, and thereby in a plane parallel to the oscillating movement of the vibrator. Accordingly, the vibration movement and the resulting inertial forces do not have any influence on the size of the air gap, and thereby the demands on the bearing structure of the rotor are decreased and/or smaller air gaps can be implemented.

In a further embodiment of the invention, the drive gear mechanism of at least one drive unit has a translation ratio that is not a whole number. In this way, the stress on the electric motor is reduced, because in this way periodic vibrations and stresses that result from vibrating use act alternately on different regions or parts in the motor. Thus, for example, the bearing of the rotor (inner bearing ring) is not stressed with the maximum load at the same location during every vibration. Furthermore, periodically recurring current peaks affect different coils in the electric motor, and thereby these are better protected against overheating/overload. Also, repeated mechanical stress on critical regions is reduced. A translation ratio that is not a whole number reduces the stress on the electric motor to a particular extent in the case when the phase position of the generator gear mechanism is supposed to be adjusted using the drive motor instead of a pivot drive.

Furthermore, the translation ratio that is not a whole number has an effect on the cooling of the electric motor: The conductors in the electric motor through which current flows heat up as the result of the power loss and must constantly be cooled during operation. As a result of the vibrating work process, torques that also have periodic variations over time, the frequency of which torques is a whole-number multiple of the generator frequency, occur in the generator gear mechanism. The periodically varying torque results in a periodically varying current flow. If the drive gear mechanism is now structured with a translation that is not a whole number, then different regions are affected by the high current flow during consecutive cycles. In an ideal case, the translation is selected in such a manner that the high currents in consecutive cycle periods act on the conductors or the coils of different pairs of poles. Consequently, heating of the motor becomes more uniform, and thereby cooling is improved, i.e., local overheating is avoided.

In a further development of the invention, the enveloping circle diameter of at least one electric motor of a drive unit is greater than the distance between the shaft connected to the unit and an adjacent shaft of the generator gear mechanism. In this way, a more compact construction, in particular a reduced length of the electric motor, and thereby also of the drive unit, is made possible.

In an embodiment of the invention, a deflector is arranged between the electric motor and the drive gear mechanism, wherein preferably a gap seal is provided between deflector and drive gear mechanism, in particular between the drive pinion of the drive gear mechanism and the deflector. In this way, contact of large amounts of gear oil with the seal and the end face of the electric motor is prevented. In this way, the flow of heat from the gear oil to the clearly cooler electric motor is reduced, and thereby the motor can be operated at a greater power. The temperature of the gear oil for lubrication of the vibration gear mechanism is usually approximately 80° C. to 100° C., whereas in the case of commercially available electric motors, a reduction in power (derating) already takes place at coolant temperatures between 45° C. to 65° C. In the case of contact-free seals, such as gap seals, groove seals, and labyrinth seals, the sealing effect of narrow gaps is utilized. The sealing effect is achieved by means of lengthening the flow path through the gap to be sealed, and thereby the flow resistance is significantly increased. Gap seals are wear-free, and no noteworthy friction-related power losses occur.

An object of the invention is furthermore a vibrating pile driver having a vibration generator of the aforementioned type according to the invention. Preferably, the vibration generator of the vibrating pile driver is structured as an upright vibrator.

In a further development of the invention, the vibrating pile driver is configured as a free-riding vibrating pile driver, also called a free rider.

An object of the invention is furthermore a vibrating pile-driving device comprising a support frame having a leader, on which a working device carriage is displaceably arranged, to which carriage a vibrating pile driver having a vibration generator of the aforementioned type according to the invention is attached.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the Drawings,

FIG. 1 shows the schematic representation of a vibrating pile-driving device, with support frame and leader;

FIG. 2 shows the schematic representation of the vibration generator of the vibrating pile-driving device from FIG. 1 in a side view;

FIG. 3 shows the schematic spatial representation of the vibration generator from FIG. 2, with a drive unit in an exploded representation;

FIG. 4 shows the schematic representation of the vibration generator from FIG. 2 in the section view A-A;

FIG. 5 shows the detail representation of a drive unit of the representation from FIG. 4;

FIG. 6 shows the schematic representation of the vibration generator from FIG. 2 in the view from the front, and

FIG. 7 shows the schematic representation of the vibration generator from FIG. 6 in the section B-B.

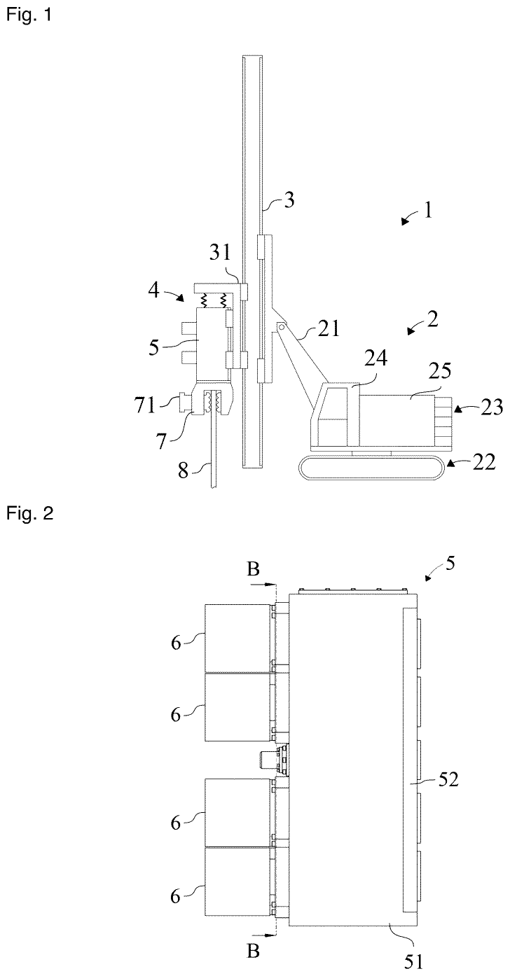

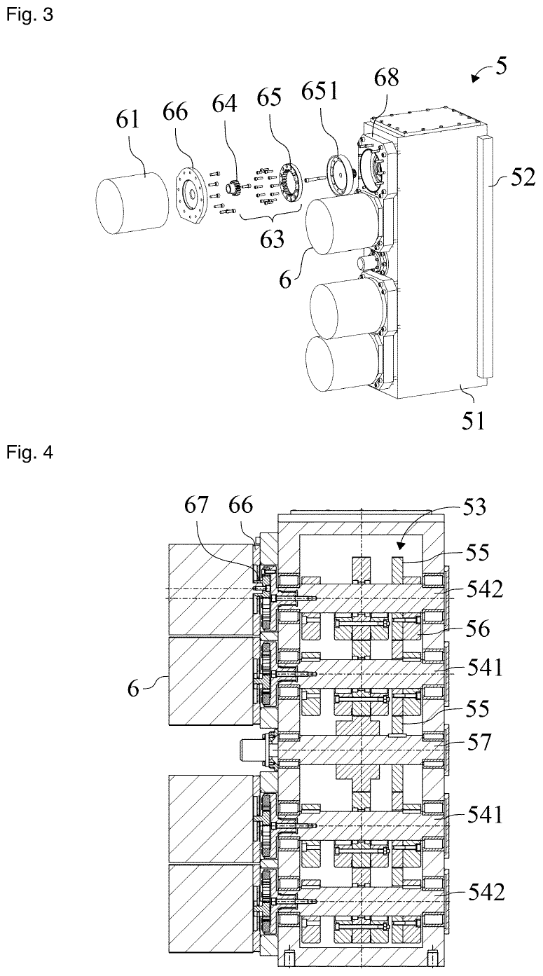

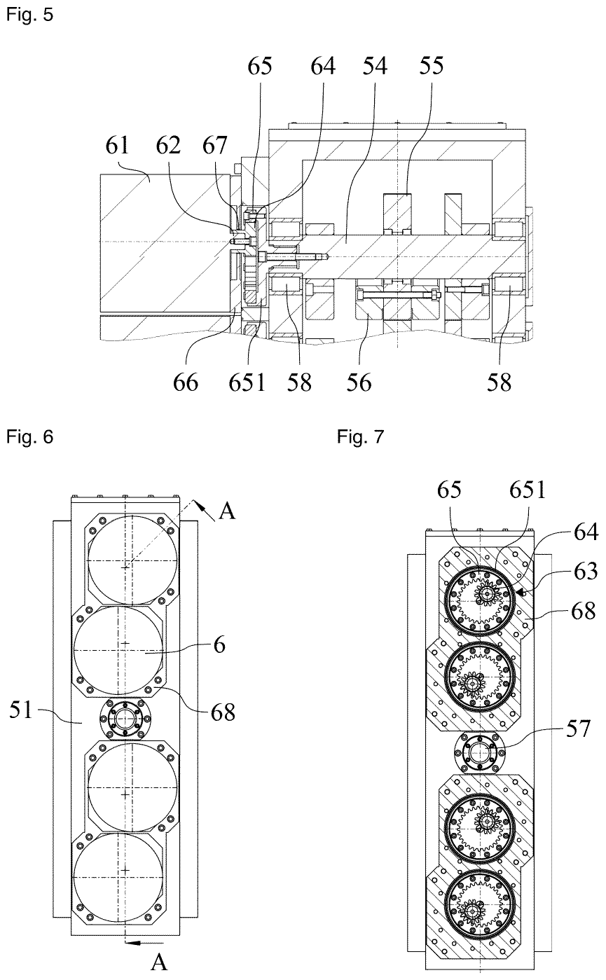

### DETAILED DESCRIPTION OF PREFERRED EMBODIMENTS

The vibrating pile-driving device 1 selected as an exemplary embodiment comprises a support frame 2, which is connected to a leader 3 by way of a kinematic part 21, on which leader a working device carriage 31 is displaceably arranged, which carriage holds a vibrating pile driver 4 that comprises a vibration generator 5 and clamping tongs 7 for holding a pile element 8.

The support frame 2 comprises an undercarriage 22 provided with a crawler track unit, on which undercarriage a superstructure 23 is arranged so as to rotate. The superstructure 23 comprises a driver's cabin 24 as well as a machine space 25, which holds an internal combustion engine, in particular a diesel engine for driving a generator for producing an electrical operating voltage, which generator is connected to a buffer battery.

The vibration generator 5 is configured as an upright vibrator and comprises a generator housing 51, which holds a generator gear mechanism 53, which is formed by four imbalance shafts 54 that are mounted so as to rotate—two outer imbalance shafts 542 and two inner imbalance shafts 541—, which shafts are provided with gear wheels 55 and with imbalance masses 56, as well as by an intermediate shaft 57 provided with gear wheels 55, which shaft is arranged in the center between two inner imbalance shafts 54. (The intermediate shaft 57 is not directly evident in FIG. 7—the reference number 57 here points to the visible fixed rotational passage behind which the intermediate shaft is arranged.) The imbalance shafts 541 and the intermediate shaft 57 are mounted, in each instance, by way of two bearings 58 that are held by the generator housing 53 and configured as cylinder roller bearings, so as to rotate in the generator housing 53, and are connected to one another by way of the gear wheels 55. The generator housing 51 has a connection strip 52, in each instance, on two opposite side walls, as a guide on the working device carriage 31 of the leader 3. The vertical forces are transferred by means of elastomer elements—not shown—from the working device carriage 31 of the leader 3 to the generator housing 51.

On its front side, which lies opposite the connection strips 52, four drive units 6 for driving one of the imbalance shafts 54, in each instance, are arranged on the outside of the generator housing 51 of the vibration generator 5.

The drive units 6 each comprise an electric motor 61, which is connected to a drive gear mechanism 63. In the exemplary embodiment, the electric motor 61 is a reluctance motor. By means of the use of four drive units, each having an electric motor 61, the electric motors 61 have a relatively slight construction height. This construction height can thereby be reduced even further if disk motors are used as electric motors 61.

The drive gear mechanism 63 is formed by a drive pinion 64 that is in engagement with the inner gear teeth of a hollow gear wheel 65. The interlocking of drive pinion 64 and hollow gear wheel 65 is selected in such a manner, in this regard, that the drive gear mechanism 63 has a translation ratio that is not a whole number. The drive pinion 64 is connected to the motor shaft 62 of the electric motor 61 in a torque-proof manner. The hollow gear wheel 65 is connected to the corresponding imbalance shaft 54 of the generator gear mechanism 53, in a torque-proof manner, by way of a drive plate 651 to which it is attached. A deflector in the form of a deflector disk 66 is arranged between the drive pinion 64 of the drive gear mechanism 63 and the electric motor 61. A contact-free seal 67, in the present case a gap seal, is arranged between the drive pinion 64 of the drive gear mechanism 63 and the deflection disk 66. The motor shaft 62 of the electric motor 61 is arranged radially offset from the imbalance shaft 54 connected to it by way of the drive gear mechanism 63. In the exemplary embodiment, two adjacent drive gear mechanisms 63 are arranged in a common gear mechanism housing 68, in each instance, which housing is attached to the generator housing 51 of the vibration generator 5 by means of screws. Of course, each drive gear mechanism 63 can also be arranged in a separate drive housing.

The electric motors 61 of the drive units 6 are electrically connected to the buffer battery—not shown—of the support frame 2.

Although only a few embodiments of the present invention have been shown and described, it is to be understood that many changes and modifications may be made thereunto without departing from the spirit and scope of the invention.

1. A vibration generator for a vibrating pile driver (4), comprising a generator housing (51), in which a generator gear mechanism (53) is arranged, wherein the generator gear mechanism comprises at least two shafts (54) arranged parallel to one another, wherein the at least two shafts are mounted so as to rotate in bearings (58) held by the generator housing (51) and are connected to at least one drive by means of which the at least two shafts are put into rotation, as well as at least two imbalance masses (56), which are attached to one or more of the shafts (54), wherein the at least one drive is formed by a drive unit (6), in each instance, which comprises an electric motor (61) and a drive gear mechanism (63) connected to the electric motor, wherein the at least one drive unit (6) is arranged on the generator housing (51), on the outside, in such a manner that it the at least one drive unit (6) is positioned offset from the bearings (58) held by the generator housing (51), in the direction of the axes of rotation of the shafts (54), and not axially between two bearings (58) of a shaft, wherein the drive gear mechanism (63) is connected to at least one of the shafts (54).

2. The vibration generator according to claim 1, wherein the drive gear mechanism (63) of the at least one drive unit (6) is structured as a gear wheel mechanism.

3. The vibration generator according to claim 1, wherein each of the shafts (54) is provided with at least one imbalance mass (56), wherein preferably an intermediate shaft (57) that does not have an imbalance mass is arranged between two of the shafts (54).

4. The vibration generator according to claim 1, wherein at least two shafts (54), preferably all of the shafts (54) are connected to a drive unit (6), in each instance.

5. The vibration generator according to claim 1, wherein at least one drive unit (6) formed by a drive gear mechanism (63) and an electric motor (61) is firmly connected to the generator housing (51).

6. The vibration generator according to claim 1, wherein the drive gear mechanism (63) of at least one drive unit (6) comprises at least two, preferably precisely two meshing gear wheels (64, 65), wherein one of the gear wheels (64) is driven by the electric motor (61), and the other gear wheel (65) is connected to one of the shafts (54).

7. The vibration generator according to claim 1, wherein the drive gear mechanism (63) of at least one drive unit (6) has an output axle that is offset radially from the drive axle.

8. The vibration generator according to claim 6, wherein the gear wheel (64) of the drive gear mechanism (63) of the at least one drive unit (6), the gear wheel is being driven by the electric motor (61), is configured as a spur gear having teeth on the outside, wherein the output-side gear wheel, which is connected to one of the shafts (54), is configured as a hollow gear wheel (65), wherein the motor shaft (62) of the electric motor (61) of the drive unit (6) is arranged at a radial offset from the shaft (54).

9. The vibration generator according to claim 1, wherein at least two shafts (54) of the generator gear mechanism (53) are connected to one another by way of gear wheels (55).

10. The vibration generator according to claim 1, wherein at least one motor (61) of a drive unit (6) is a synchronous motor excited from the outside, a reluctance motor, or an asynchronous motor.

11. The vibration generator according to claim 1, wherein the drive gear mechanism (63) of at least one drive unit (6) has a translation ratio that is not a whole number.

12. The vibration generator according to claim 1, wherein the enveloping circle diameter of at least one electric motor (61) of a drive unit (6) is greater than the distance between the shaft (54) connected to this unit and an adjacent shaft (54) of the generator gear mechanism (53).

13. The vibration generator according to claim 1, wherein a deflector (66) is arranged between the electric motor (61) and the drive gear mechanism (63) of at least one drive unit (6), wherein preferably a contact-free seal (67) is arranged between deflector (66) and drive gear mechanism (63).

14. The vibration generator according to claim 1, wherein the vibration generator is configured as an upright vibrator.

15. A vibrating pile driver comprising the vibration generator (5) according claim 1, wherein this pile driver is configured as a free-riding vibrating pile driver.

16. A vibrating pile-driving device, comprising a support frame (2) having a leader (3) on which a working device carriage (31) is displaceably arranged, to which carriage a vibrating pile driver (4) is attached, which comprises the vibration generator (5) according to claim 1.
